(19) United States
(12) Patent Application Publication
(10) Pub. No.: US 2021/0297810 A1
(43) Pub. Date: Sep. 23, 2021

(54) AUTHORIZING A DATA COMMUNICATION WITH AN ELECTRONICALLY CONTROLLED PUMP UNIT

(71) Applicant: GRUNDFOS HOLDING A/S, Bjerringbro (DK)

(72) Inventors: Flemming MUNK, Viborg (DK); Casper Lyngesen MOGENSEN, Skals (DK); Jacob HANSEN, Næstved (DK)

(21) Appl. No.: 16/473,466

(22) PCT Filed: Dec. 6, 2017
(86) PCT No.: PCT/EP2017/081664

§ 371 Date: Jun. 25, 2019

(30) Foreign Application Priority Data
Dec. 20, 2016 (EP) 16205238.5

(51) Int. Cl. H04W 4/029; H04W 4/021; H04W 4/02; H04W 12/06; H04W 84/12; F04D 15/00; H04W 64/00; H04W 48/04

(52) U.S. Cl. CPC H04W 4/029; H04W 4/021; H04W 4/023; H04W 48/04; H04W 84/12; F04D 15/0088; H04W 64/003; H04W 12/06

(57) ABSTRACT

A method for authorizing a data communication between an electronically controlled pump assembly (1) and an operating device (12), configured for wireless communication with the pump assembly (1), operating using an external server (10) connected to a data network. The method includes transferring the installation location data (GPS 1) of the pump assembly (1) to the server (10) via the data network. An identification code of the operating device (12) and the location data (GPS 2+3) of the operating device (12) are then transferred to the server via the data network. On the server side, it is examined whether the operating device (12) is envisaged for data communication with the pump assembly (1), and whether the operating device (12) is located in a predefined spatial region (A) to the pump assembly (1). Subsequently a data communication is enabled or blocked, for a time.

### CROSS REFERENCE TO RELATED APPLICATIONS

This application is a United States National Phase Application of International Application PCT/EP2017/081664, filed Dec. 6, 2017, and claims the benefit of priority under 35 U.S.C. § 119 of European Application 16 205 238.5, filed Dec. 20, 2016, the entire contents of which are incorporated herein by reference.

### TECHNICAL FIELD

The invention relates to a method for authorizing data communication between an electronically controlled appliance, in particular an electronically controlled pump assembly and an operating device, as well as to an electronically controlled pump assembly with control electronics which are designed for carrying out this method.

### TECHNICAL BACKGROUND

With electronically controlled pump assemblies, it is counted as belonging to the state of the art to set operating parameters and/or operating data, after the installation or also given a later servicing, examination and the like, so that the pumps which are activated by the control electronics run in the desired operating mode and as a rule in an energy-optimised manner. This can be effected by way of carrying out respective settings at an operating panel of the pump, but this nowadays is advantageously effected via an operating device which is designed for wireless communication with the electronically controlled appliance, in particular with the electronically controlled pump assembly.

Thereby, it has be found to be useful not to provide a special operating device for each appliance, which would be comparatively complicated and expensive, but to carry out the operation via generally available operating devices such as smartphones, tablets or mobile PCs, which fulfil all requirements necessary for the display, operation and communication. However, a problem with this is to ensure that only authorized devices and authorize persons obtain access, be it them only requesting data or also data being inputted. An authorization is therefore always necessary before the beginning of a data communication between the operating device and the appliance.

As in WO 2016/078686 A1, it is counted as belonging to the state of the art to realize such an authorization by way of an external, typically cloud-based server which is connected to a data network. This method has basically proven its worth, but however has a few disadvantages with regard to the authorization security, which are inherent of the system. Non-authorized access cannot be ruled out with the necessary security, due to the fact the operating device also wirelessly communicates with the appliance, be it directly or indirectly via the server.

### SUMMARY

Against this background, it is an object of the invention, to improve a method for authorizing a data communication between an electronically controlled appliance, in particular an electronically controlled pump assembly and an operating device, in particular to ensure to a high degree, that a data communication is only effected if this is carried out in a designated manner between an operating person with the operating device and the appliance. Moreover, an electronically controlled pump assembly which is suitable for application with the authorization method according to the invention is to be provided.

The method according to the invention, for authorizing a data communication between an electronically controlled appliance, in particular an electronically controlled pump assembly and an operating device configured for wireless communication with the appliance, and with which an external, data-network-connected, preferably cloud-based server is applied, is organised such installation location data of the appliance is firstly transferred to the server via the data network. This installation location data not only specifies the installation location, but can also define the appliance itself by way of the installation location.

An identification code belonging to the operating device as well as the current location data of the operating device is transferred to the server via the data network, for authorising the data communication.

On the server side and on the basis of the identification code of the operating device, it is firstly determined as to whether it is the case of an operating device which is basically envisaged for data communication with the appliance, i.e. envisaged on the manufacturer side.

In a further step, on the server side and on the basis of the installation location data and the current location data of the operating device, it is then determined as to whether the operating device is situated in a predefined spatial region to the appliance.

The data communication between the appliance and the operating device is enabled at least temporarily, i.e. for a defined time duration, if on the one hand the basic authorization for data communication with the appliance is ascertained on the basis of the identification code of the operating device, and furthermore on the other hand it is ascertained in particular on the basis of the spatial arrangement between the installation location and the operating device, that the operating device is located in the predefined spatial region to the installation location of the appliance.

The method according to the invention, in comparison to the known authorization method, has the significant advantage that apart from the requirement of the operating device being envisaged at all for data communication with the appliance to be operated, authorization is only given if it is arranged at an adequate proximity to the appliance. This has the very significant advantage that firstly a data communication with devices lying outside the defined spatial region is reliably prevented, which avoids faulty operations as well as unallowable data communication with operating devices of non-authorized persons. The authorization of the data communication becomes more reliable and significantly more secure with regard to unauthorized attempts to intervene in the control of the appliance. The method according to the invention moreover also has the very significant advance that location data of different appliances is acquired on the server side and thus a complete overview concerning the spatial distribution of the appliances can be created on the manufacturer side or on the servicing company side. This is particularly advantageous for pump assemblies, since here it is the case of machines which in a constructionally equal or similar form, are distributed over the locations of application in large numbers, without their spatial distribution being known.

A pump assembly in the context of the present invention is not only to be understood as a motorically driven centrifugal pump or displacement pump with an electronic control, but it can also be understood as several pumps with several separate drives, in particular electromotoric drives, which are assigned to a common electronic control, such as in the case of booster pumps for example. With regard to the electronic control, it is typically but not necessarily the case of a power converter/frequency converter, via which the motor speed can be controlled in large ranges and thus the power spectrum of the connected pump.

Although in the simplest form, the storage of the installation location data of the individual appliances on the server side is sufficient, in order to identify these appliances as such and to permit an unambiguous assignment by way of an operating device, however it is particularly advantageous if, additionally to the installation location data, an identification code of the appliance is transferred to the server via the data network. Such an identification code is particularly advantageous when a multitude of appliances of a different type are to be authorized, since individual access authorizations can also be realised in groups, thus for example for pump assemblies of the same type, via the identification code. The transfer of an identification code moreover has the significant advantage that an unambiguous assignment between the appliance and the location is possible on the manufacturer side or operator side. Apart from the identification code, this for example also permits settings, parameters, operating data or the like to be stored on the server side, so that in the case of a defect, in particular of a complete defect, as can be caused by a fire or water damage, on the basis of the installation location data and on the server side, it can be determined as to which type of appliance it is the case of, i.e. a corresponding exchange appliance can be provided, and then the settings stored on the server side can be transmitted onto the exchange appliance, so that this replaces the defect appliance in a quasi identical manner including all settings. This merely necessitates an operating person with the operating device coming sufficiently close to the defect appliance, so that the corresponding server-side assignment can be effected. It is to be understood that this method, the authorization per se as well as the previously described exchange method in the case of a defect of the appliance is controlled in its procedure by way of a suitable software application (app) running on the operating device, in particular via a smartphone, as is nowadays counted as belonging to the state of the art with appliance installations.

Moreover, it is to be understood that the authorization method described above cannot be applied on exchanging a defect appliance, due to the fact that it is to be assumed that the defect appliance is also no longer capable of communication. In this special case, a special access authorization of the operating device which is then assigned to this location is effected on the server side, and this ensures the data access to the data concerning the defect appliance and stored on the server side and its input into the exchange appliance.

It is particularly advantageous if the installation location data is determined in an automated manner and is transferred to the server via the data network, and specifically advantageously by way of a navigation satellite system. A suitable navigation satellite system is basically used here. The NAVSTAR-GPS is most widespread at present and is advantageously used due to the fact that one the one hand a high availability is given and on the other hand the necessary hardware components are inexpensively available. Basically, the determining of the location data can also be effected via other navigation satellite systems, such as of example Glonass, Beidou or Galileo, and one can also apply different positioning (locating) systems at different locations.

A manual request and input possibility can be provided at the appliance itself, in the case of appliances, in particular pump assemblies which are arranged at a location, at which no or only a poor reception of the signals of the navigation satellite system is given, wherein the location data is then advantageously determined by way of the operating device which is equipped with such a positioning system.

It can be advantageous to determine the location data, be it the installation location data of the appliance or also that of the device, by way of an alternative or additional positioning, e.g. WLAN network positioning and/or mobile radio network positioning, particularly where the reception signals of the navigation satellite system are weak and/or imprecise as is the case of densely populated regions, thus where an exact differentiation of the location data is difficult. Such assisting and, as the case may be, also alternative positioning methods are known under the term A-GPS (assisted global positioning system) which is referred to inasmuch as this is concerned.

The distance between the appliance and the operating device is determined on the basis of the location data of the operating device and the installation location data, and it is then further determined as to whether the distance lies within a previously fixed maximal distance, in order to determine as to whether an operating device is located in a defined spatial region to the appliance. This maximal distance can be individually varied at the case may be, be it to permit a sufficient differentiation in the case of a high appliance density, or to exceptionally permit an operating access from a more remote space. Thereby, according to the invention, the regions can also be determined with regard to GPS, so that for example a greater distance to the appliance can exist in the one direction than in the other. Thereby, it is basically of no significance as to whether this determining is effected on the server side or the operating device side. Basically, it is also conceivable to permits this to be effected on the appliance side. This always entails weighing up between the available computation capability on the one hand and the signal quality to data networks of the server on the other hand.

Usefully, the predefined spatial region, in which the operating device must be located to the appliance, which is to say the allowable distance between the appliance and the operating device, will not be constant, but set or adapted depending on the accuracy of the transmitted location data. Thus the accuracy can be determined by way of the number of received satellite signals in the case of a GPS positioning/localization. Here, it is the received signal strength which will serve as a measure in the case of an additional or supplementary positioning/localizing via WLAN networks and/or a mobile radio phone network.

Advantageously, a data base with identification codes of the appliances and identification codes of the operating devices is provided on the server side, in order to ensure the basic permissibility of an authorization between an appliance and operating device, wherein the assignments, in which the data communication is envisaged are simultaneously specified. Thereby, the data communication can advantageously be enabled in a stepwise manner, so that in a first step, the permissibility of the data communication between an operating device and an appliance in the first place is determined, and in a second step its is determined as to which data and to what extent such data may be exchanged. It is thus particularly with the data communication with pump assemblies that it is advantageous to restrict a subordinate group to data communication for the display and the request of data of the appliance, in particular of the pump assembly, and for a further subordinate group to carry out a data communication for setting (adjusting) the appliance. Thus authorizations for data communication which only envisages the request of data, and others which envisage the request and input of data can be provided with the method according to the invention. With such a constellation it is advantageous to not only assign different data communications to the groups, but also different access priorities. Thus it is typically useful to assign a higher priority to the group of operating devices which is envisaged for setting the appliance, than to such a device which is only envisaged for the request of data of the appliance. It is also conceivable to differentiate the groups once again with regard to the allowable setting data, and it is then also useful to differentiate the access priorities accordingly.

According to a further development of the method according to the invention, one envisages the investigations for determining the permissibility of the data communication of an operating device with the appliance, as well as for determining whether this operating device is located in a defined spatial region to the appliance, being repeated in temporal intervals, whereupon the data communication continues to be enabled or interrupted or remains blocked, in order to ensure that a data communication with the appliance is only effected with the operating device when this device is located in the predefined region to the appliance, but without having to constantly request the locations data on the other hand. Faulty operations can be reliably prevented by way of this, since they quasi effect an automatic logging-out of the operating device in a time-dependent and location-dependent manner, on data communication with the appliance.

Instead of the above-mentioned examination in temporal intervals, the method according to the invention can also be configured such that the data communication is enabled for a predefined time interval, if on the server side, the operating device has been identified as being allowable for data communication and on the other hand this has been able to be determined as being in a defined spatial region to the appliance. The time interval is then usefully set such that if it is the case of an operating device which is only envisaged for data request, the respective operating data are displayed for a sufficient time or only briefly requested and stored, whereas with an operating device which is permitted for setting, a longer time interval permitting the operating person to carry out this setting within a reasonable time is enabled.

Moreover, it has been found to be advantageous if the appliance, if it is in operation, transfers its identification code as well as its installation location data to the server in temporal intervals. Here, operating data and/or setting data can also be transferred as the case may be, wherein the transfer of the setting data is advantageously always effected after the setting has been effected. Such a data transfer not only permits the installation location of the appliance to be monitored, but also an at least partial operational monitoring which simultaneously represents an examination of the data communication between the appliance and the server.

Basically, with regard to the implementation of the method according to the invention, it is of no significance as to whether the data communication between the operating device and the appliance is effected in a direct manner, or indirectly via the server connected to the data network. However, it is particularly advantageous if the data communication between the operating device and the appliance is effected in a direct manner, and this can be in a wireless manner, optically, acoustically or by way of radio communication. The latter is particularly advantageous with regard to setting purposes, since the direction transmission path usually represents the shortest and most secure data connection. This connection, via which a comparatively large data quantity can be exchanged, can otherwise be adapted to the local environmental conditions. Thus for example preference will be given to an infrared communication, if the available radio channels are often interrupted or congested or in explosion-proof areas.

Since the operating device as well as the appliance need to be connected to an external server connected to a data network, at least for the purpose of the authorization of the data communication, it can be useful to permit the remaining data communication between the appliance and the operating device to also run via the server, preferably in a wireless manner via radio communication in each case. However, it is also conceivable to fixedly wire the appliance to the network and to only permit the operating device to communicate in a wireless manner. Moreover, the communication via the server has the advantage that computation activities, be they for authorization or of evaluating operating data or the like can be effected on the server side, wherein as a rule sufficient computation capacity is available.

A server can be understood as a software-implemented server, thus as a program running on a computer, or as computer hardware with a read-only memory and software, which on the one hand comprises data base functions, i.e. data memory and data base software, and on the other hand comprises computation operations. Thereby, with regard to the server being cloud based, it is of no significance as to whether this server runs in any computation centre of this world, or on a computer of the manufacturer.

It can be advantageous if the spatial region in particular the distance, at which the operating device must be located to the appliance, in order for the data communication to be authorized, is specified and in particular can be set, either on the appliance side or the server side. One can thus make allowances for individual situations, for example if a multitude of appliances are to be operated in the direct proximity of one another, or if for example due to the poor signal quality of the GPS signals in the direct proximity of the device, the operating device needs to be authorized at certain distance in front of this, for example out in the open in front of a building.

The method according to the invention, on the operating device side, is advantageously carried out on a smartphone, tablet or notebook, wherein a software application running on the operating device and carrying out the method-related communication with the server and the appliance is provided. The identification code of the operating device can thereby be advantageously specified in the software application, since operator groups can then be formed solely via the software application. The location data is thereby transmitted to the server via this software application, when using a smartphone or tablet with an installed GPS receiver. A GPS receiver can be externally connected as the case may be, typically in the case of notebooks, which do not often have their own GPS receiver.

The method according to the invention is particularly advantageous for use with pump assemblies, but is not restricted to this. It is particularly the authorization of the data communication between an operating device and an appliance for monitoring bacteria in water, as is offered by the applicant under the description BACNON, which is cited here as a predestined application.

The method according to the invention is advantageously applied in combination with an electronically controlled pump assembly comprising control electronics, with which at least one electric motor driving a pump, in particular a centrifugal pump can be activated. Such pump assemblies are to be found for example in heating facilities, but also in wastewater facilities, pressure boosting facilities, in waterworks, on building sites and the like. The control electronics are thereby typically part of power converter electronics, in particular frequency converter electronics, with which the speed of the electric motor and thus of the pump connected thereto can be changed in wide ranges.

Such a pump assembly is equipped with means for data communication with at least one external, network-connected server and is characterised in that means for position determining are provided on the pump assembly side. These can advantageously be a GPS receiver, alternatively or additionally a WLAN receiver, as well as alternatively or additionally a mobile radio receiver. Thereby, it is particularly advantageous if several such reception modules are provided, so that a position determining can also be carried out if the reception signals are weak or if a further differentiation is necessary.

Since pump assemblies of the type being discussed here are often located at difficultly assessable locations which are shielded or covered by concrete ceilings or the like, it is advantageous if, apart from the reception module or modules which can automatically determine the location, the control electronics are configured so as to also be able to manually input the position data. This, at least on installation for the first time can then basically also be effected by the operating device whilst using the corresponding software application. In this context, it can be advantageous, apart from the receivers for determining the position, to equip the pump assembly with an infrared or Bluetooth receiver, in order to be able to ensure that the installing operating device is located in the direct proximity. This position data which are inputted once are then advantageously stored in the control electronics of the pump assembly, wherein a reset switch can be provided, which deletes this data as soon as the cover of the terminal box is opened, thus the pump assembly is disconnected from the mains.

Thereby, advantageously not only can the position data be inputted, but also region variables. The latter is advantageously also effected only as a one-time event in an application-controlled manner, with installation for the first time.

The invention is hereinafter explained in more detail by way of an embodiment example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly simplified symbolic representation of a data-network-connected pump assembly and operating device for data communication;

FIG. 2 is a view of a display of the operating device in positions GPS 3 of FIG. 1;

FIG. 3 is a view of the display of the operating device in position GPS 2 of FIG. 1; and

FIG. 4 is a method procedural diagram for authorising the data communication between an electronically controlled pump assembly and an operating device.

### DESCRIPTION OF PREFERRED EMBODIMENTS

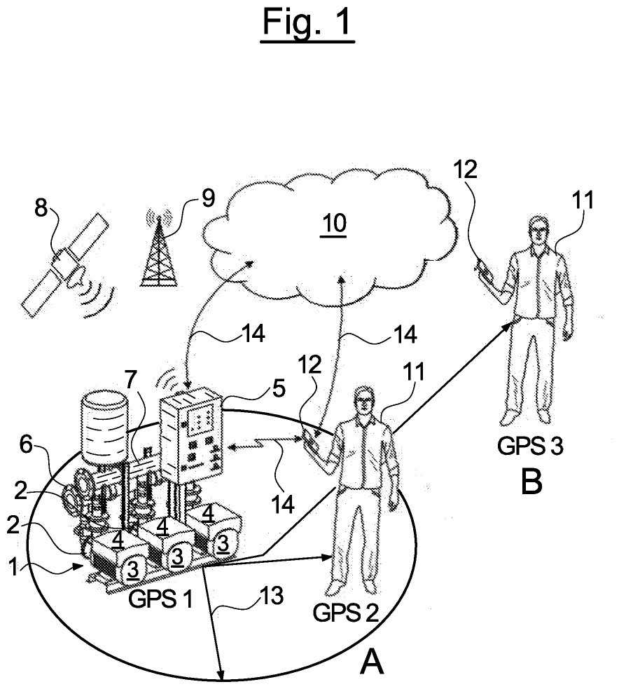

Referring to the drawings, a pump assembly 1 which contains three centrifugal pumps 2 which are connected in parallel, are driven in each case via an electric motor 3 with an assigned frequency converter 4 and which are operated or coordinated via a central electronic control 5, is represented in FIG. 1. Here, the electronic control 5 is arranged as an external subassembly, but it is to be understood that this can also be part of control electronics of a frequency converter 4, if for example a centrifugal pump 2 with a connected electric motor 3 is operated individually.

The represented pump assembly delivers from a suction conduit 6 into a delivery conduit 7, and can be part of a wastewater system or freshwater system. The electronic control 5 comprises a GPS receiver, which in a manner known per se receives data from satellites and determines the position of the pump assembly 1 on the basis of their time-of-flight time differences. The electronic control 5 moreover comprises a mobile radio communication receiver which at least receives mobile radio communication data from a mobile radio communication emitter 9, this likewise being for location determining or for increasing the accuracy of the GPS localization which is necessary as the case may be.

The electronic control further comprises a WLAN module, via which a data connection to an external server 10 connected to a data network, here symbolised as a cloud 10, can be created.

The position of the pump assembly, i.e. the installation location is indicated in FIG. 1 by GPS 1 and here for example corresponds to an eastern longitude of 9.34320 and a northern latitude of 56.57949.

An operating person 11 is located at the location GPS 2 which for example has an eastern longitude of 9.34324 and a northern latitude of 56.57952. The operating person 11 carries an operating device 12 in the form of a smartphone in his hand. The same operating person 11 with the operating device 12 is represented at GPS3, however in a position of 9.34291 eastern longitude and 56.57949 northern latitude.

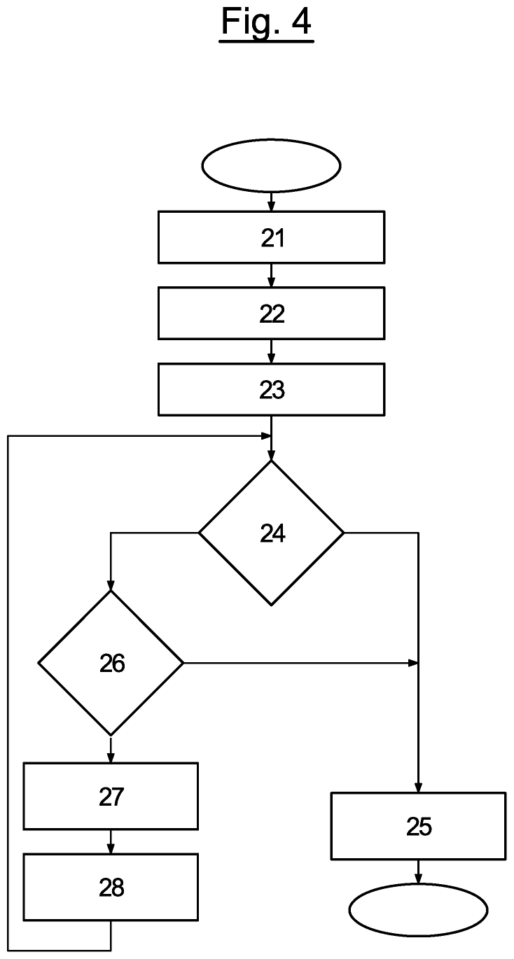

It is represented as to how the authorization of a data communication between the electronic control 5 of the pump assembly 1 and the operating device 12 is effected with the help of determining of the positions as well as of the cloud-based server 10, by way of the procedural diagram of FIG. 4.

The electronic control 5 is switched on by an operating person or is controlled for the process of an authorization method, after the pump assembly 1 is installed and connected. In a first step 21, the installation location is determined on the pump assembly side, i.e. the installation location data is determined with the help of the installed GPS receiver. Thereby, the electronic control 5 is configured such that if the accuracy of the GPS reception falls short of a predefined minimum valve (number of the received satellites), then the determining of the location is effected additionally or even alternatively by means of the mobile radio communication reception and/or WLAN networks, as is known per se with assisted GPS, which is referred to in this context. As soon as the installation location data is determined on the pump assembly side, this is transferred to the cloud-based server 10 in a wireless manner, i.e. via WLAN, and then via the internet, together with an identification code of the pump assembly.

In a second step 22, a region A which defines the spatial region, in which the operating device 12 must be located, in order to be authorized for data communication, is determined on the server side and on the basis of this installation location data indicated at GPS 1. This region A is defined by a distance 13 which defines the radius of a circle around the installation location GPS 1.

In a third step 23, the identification code of the operating device 12 as well as the location of the operating device 12 are transmitted on the operating device side. Also on the operating device side, the location is primarily supplemented via GPS localisation, but secondarily also via mobile radio positioning and WLAN positioning (A-GPS) as the case may be.

Then, in a fourth step 24, it is examined on the server side as to whether the identification code of the operating device 12 is that one which is approved for data communication with the electronic control 5 of the pump assembly 1. For this, the identification codes of the possible pump assemblies as well as the identification codes of the possible operating devices are acquired and assigned on the server side, according to the data base.

If with regard to the server-side examination 24, it is ascertained that the operating device 12 is not envisaged for data communication with the pump assembly 1, then the authorization process is terminated in step 25 and the access for data communications fails.

If however the result of the examination 24 is that it is the case of an operating device 12 which is envisaged for data communication with the pump assembly 1, then in a second examining step 26, it is examined on the server side as to whether the operating device 12 is located in the predefined region A which is defined by the distance 13 around the installation location GPS 1. If, as is the case with the location GPS3, the result of the examination is that the operating device 12 is arranged outside the region A, specifically in the region B surrounding the region A, then in step 25 the data access is blocked and the authorization method ended. However, if it is ascertained that this lies within the region A, such as is the case for example at the location GPS 2, then a data communication between the pump assembly 1 and the operating device 12 is authorized in a step 27, wherein the data communication 14 between the operating device 12 and the electronic control 5 of the pump assembly 1 is effected in a direct manner. This data communication can alternatively also be envisaged only indirectly, i.e. via the server 10.

The examinations 24 and 26 are repeated in a step 28, which is effected after a predefined time, in order to ensure that a data communication is only effected as long as the operating device 12 is located within the region A. As the case may be, one can forgo an examination 24, so as to simplify the method.

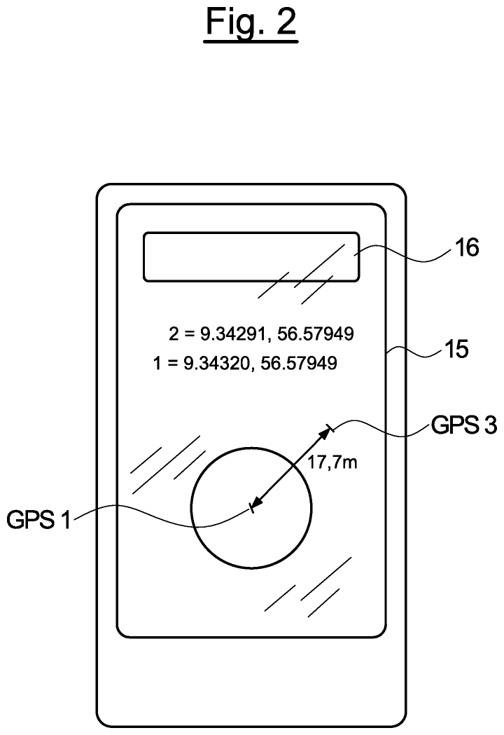

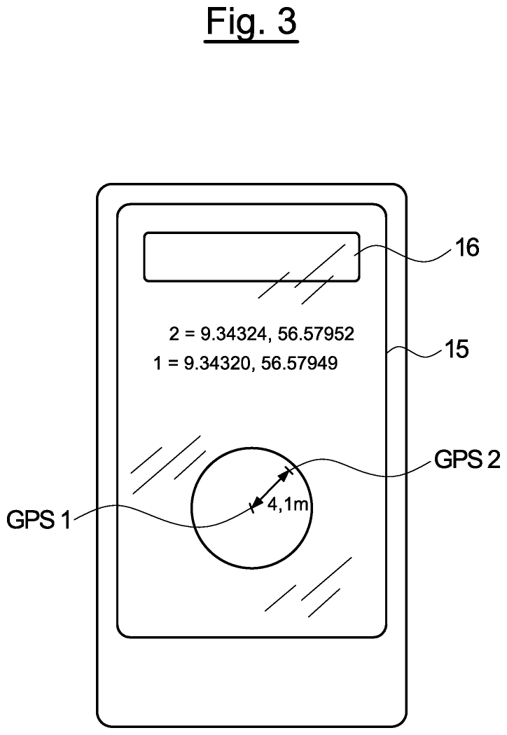

As to how the display of the operating device 12 looks is represented in FIGS. 2 and 3, wherein this operating device here is a smartphone, on which a corresponding software application runs. The installation location GPS 1 is marked in the lower half of the display, as well as the region A by a circle at a distance 13 around the installation locations GPS 1. The GPS coordinates of the pump assembly 1 as well as those of the operating device 2 are moreover indicated in the upper third. A display field 16, represented in green given an authorization and in red given a non-authorization, with a corresponding text therein “authorization effected” (in the green field) or “authorization failed” (in the red field), is moreover represented.

In the present procedural diagram, only one examination 24 is envisaged, which examines as to whether the operating device 12 is envisaged for operating the pump assembly 1. This examination 24 can be divided into two or more sub-examinations, if for example a first group of operating devices envisaged exclusively for data communication is formed and acquires and displays operating data of the pump assembly, whereas a second group with which the operating parameters of the pump can be set can be formed, and wherein a third group, so-called master operating devices can be provided, with which all settable/adjustable data of the pump assembly can be set. Thereby, the assignment of the groups is not effected via the operating device 12 itself, but is implemented in the software, i.e. by way of the software application, with which the operating device 12 on the one hand communicates with the electronic control 5 of the pump assembly 1 and on the other hand with the server 10, and which determines the operating surface.

While specific embodiments of the invention have been shown and described in detail to illustrate the application of the principles of the invention, it will be understood that the invention may be embodied otherwise without departing from such principles.

1. A method for authorizing a data communication between an electronically controlled appliance and an operating device configured for wireless communication with the appliance using an external server connected to a data network, the method comprising the steps of:
transferring installation location data of the appliance to the server via the data network;
transferring an identification code of the operating device and location data of the operating device to the server via the data network;
determining, on a server side and on the basis of the identification code, whether the operating device is envisaged for data communication with the appliance;
determining on the server side and on the basis of the location data, whether the operating device is located in a predefined spatial region relative to the appliance; and
enabling on the server side, a data communication between the appliance and the operating device at least temporarily if the determination that the operating device is envisaged for data communication with the appliance is positive and if the determination that the operating device is located in a predefined spatial region relative to the appliance is positive.

2. A method according to claim 1, wherein with the step of transferring installation location data of the appliance to the server via the data network, an identification code of the appliance is also transferred to the server via the data network.

3. A method according to claim 1, wherein
the installation location data is determined on an appliance side by way of a navigation satellite system or is inputted manually at the appliance, and
the location data of the operating device is determined by way of a navigation satellite system.

4. A method according to claim 3, wherein the location data is alternatively or supplementarily determined by way of WLAN positioning and/or mobile radio network positioning.

5. A method according to claim 1, wherein for determining whether the operating device is located in a predefined spatial region relative to the appliance, a distance between the appliance and the operating device is determined on the server side and on the basis of the installation location data and the location data of the operating device and it is further determined whether the distance lies within a previously fixed maximal distance.

6. A method according to claim 1, wherein
the installation location data and/or the location data of the operating device as well as data concerning accuracy of the location data are transferred to the server and/or the operating device,
on the server side or operating device side, the predefined spatial region is set or adapted depending on the accuracy of the transferred location data.

7. A method according to claim 1, wherein
a data base with the identification codes of the appliances and with the identification codes of the operating devices is created on the server side, in which data base the assignments envisaged for data communication are specified,
the assignments of the operating devices are formed in groups,
a superordinate group defines the enabling of the data communication of the appliance with the operating device, and at least one subordinate group qualitatively sets the data communication.

8. A method according to claim 7, wherein a subordinate group limits the data communication to the display and request of data of the appliance, and a further subordinate group permits data communication for setting the appliance.

9. A method according to one of the claim 7, wherein access priorities are assigned to the groups.

10. A method according to claim 1, wherein the determination that the operating device is envisaged for data communication with the appliance and the determination that the operating device is located in a predefined spatial region relative to the appliance are repeated in temporal intervals, whereafter the data communication is enabled, interrupted or remains blocked.

11. A method according to claim 1, wherein the data communication is enabled for a predefined time interval and is thereafter automatically uninterrupted.

12. A method according to claim 1, wherein on operation, the appliance sends the identification code and the installation location data to the server in predefined temporal intervals.

13. A method according to claim 1, wherein the data communication between the operating device and the appliance is effected directly and wirelessly, optically, acoustically or via radio communication.

14. A method according to claim 1, wherein the data communication between the appliance and the operating device is effected via the server wirelessly via radio communication.

15. A method according to claim 1, wherein the spatial region is set, either on the appliance side or on the server side.

16. A method according to claim 1, wherein
a smartphone, tablet or notebook is used as an operating device, on which a software application is installed for method-related communication with the server and the appliance, and
the identification code is set or formed in the software application, and the location data is determined via at least one receiver which is installed in the operating device or is connected thereto.

17. An electronically controlled pump assembly comprising:
control electronics
at least one electric motor
at least one pump driven by the motor;
communication means for data communication with at least one external network-connected server; and
position determination means for determining a position of installation of the pump assembly at the pump assembly.

18. A pump assembly according to claim 16, wherein the position determination means for position determining comprise a GPS receiver and/or a WLAN receiver and/or a mobile radio receiver.

19. A pump assembly according to claim 17, wherein the control electronics are configured for inputting position data and/or region variables.
